(19) United States
(12) Patent Application Publication
(10) Pub. No.: US 2002/0092767 A1
(43) Pub. Date: Jul. 18, 2002

(54) Multiple array microfluidic device units

(75) Inventors: Torleif Ove Bjornson, Gilroy, CA (US); Timothy F. Smith, Martinez, CA (US)

Correspondence Address: PERKINS COIE LLP, P.O. BOX 2168, MENLO PARK, CA, 94026, US

(73) Assignee: ACLARA BioSciences, Inc.

(21) Appl. No.: 09/995,909

(22) Filed: Nov. 28, 2001

Related U.S. Application Data
(63) Continuation of application No. 09/557,519, filed on Apr. 25, 2000.
Application No. 09/557,519 is a continuation-in-part of application No. 09/153,814, filed on Sep. 15, 1998, now Pat. No. 6,284,113.
(60) Provisional application No. 60/059,333, filed on Sep. 19, 1997.

(51) Int. Cl. G01N 27/26; G01N 27/447

(52) U.S. Cl. 204/451; 204/452; 204/601; 204/603

(57) ABSTRACT

Microfluidic unit arrays and their use are provided for performing in parallel a plurality of operations. The units are arrayed in a format comparable to microtiter well formats, so that transfer by a dispenser having a plurality of dispensing units can be performed with the same footprint, the format of the source and microfluidic unit receiving reservoirs are substantially the same. Operations are carried out simultaneously under comparable conditions, which permits more exact comparisons between the operations.

### CROSS-REFERENCE TO RELATED APPLICATIONS

This application is a continuation-in-part of application Ser. No. 09/153,814, filed Sep. 15, 1998, based on provisional application serial No. 60/059,333, filed Sep. 19, 1997, now expired, which disclosures are incorporated herein by reference.

### TECHNICAL FIELD

The field of this invention is microfluidic device arrays.

### BACKGROUND

The advent of nanotechnology has found application in miniaturizing devices and methodologies. This reduction in size provides advantages in reducing the amount of reagents and samples required, ease of manipulation, speed and simplicity of equipment. In addition, by using electokinesis, one can perform separations, relate mobility to specific entities, perform mobility shifts, etc. These advantages have opened opportunities in genetic analysis, high throughput screening for drug discovery, performing chemical operations, as well as other manipulations.

In many instances there is an interest in simultaneous or parallel operations involving a plurality of events, where there is a common aspect to some or all of the events. For example, in high throughput drug screening, there may be a common reagent, such as an enzyme, surface membrane protein or cell, which would be used to determine activity of the candidate compounds. By having the evaluations run simultaneously in the same environment, a more accurate comparison may be made of the results. One may be reassured that the evaluation has been performed under substantially the same conditions with the same reagent or sample, where all of the operations are carried out in parallel.

It is, therefore, of interest to provide devices that afford opportunities to perform operations in parallel, with simultaneous and/or consecutive additions of operation components. Preferably, such devices would allow for performing the operation under substantially identical conditions. Also, such devices would have enhanced value by being capable of being integrated with other devices that are presently available and find use in operations that are in part displaced by the use of microfluidic devices.

Relevant Literature

U.S. Patents of interest include U.S. Pat. No. 4,952,266; 4,965,049; 5,030,418; 5,104,621; 5,356,525; 5,589,330; and 5,658,413. U.S. Pat. No. 5,324,401 describes a multiplexed capillary electrophoresis system. U.S. Pat. No. 5,332,480 describes a multiple capillary electrophoresis device. U.S. Pat. No. 5,277,780 describes a two dimensional electrophoresis apparatus. U.S. Pat. No. 5, 413,686 describes a multi-channel automated capillary electrophoresis analyzer. U.S. Pat. No. 5,4439,578 describes a multiple capillary biochemical analyzer based on an array of separation capillaries terminating in a sheath flow cuvette. U.S. Pat. No. 5,338,427 describes a single use capillary cartridge having electrically conductive films as electrodes. U.S. Pat. Nos. 5,091,652 and 4,675,300 describe means for detecting samples in a capillary. U.S. Pat. No. 5,356,525 descibes a device for presentation of a tray of 7 vials of sample to an array of 7 capillaries for the sample injection process. U.S. Pat. Nos. 5,043,215; 4,927,604; 5,108,704; and 5,219,528 describe multi-well devices with integral membranes. U.S. Pat. Nos. 4,925,629; 4,626,509; 5,213,776 and 5,525,302 describe multi-channel metering devices. A multi-well plate is described in PCT WO 97/15394. See also, WO 99/24827. Articles of interest include Wooley and Mathies, Proc. Natl. Acad. Sci. USA 91, 11348-11352 (1994) and Wooley, et al., Anal. Chem. 69,2181-2186 (1997)

### SUMMARY OF THE INVENTION

Microfluidic devices are provided comprising an array of repetitive sample receiving and processing units in a single substrate. Each repetitive unit comprises microstructures of reservoirs and interconnected channels and is adapted for integration with microfluidic fluid flow control and detectors, whereby operations of mixing, separation, reaction, and detection may be performed. A main channel in which a primary operation is performed will normally be repeated in each unit being uniformly spaced apart in two directions. The arrays are primarily designed for use in conjunction with other devices having regular arrays, such as microtiter well plates.

### DESCRIPTION OF THE SPECIFIC EMBODIMENTS

In accordance with the subject invention microfluidic devices are provided, which can be used as part of an assembly comprising integral first and second plates, where the second plate is a microfluidic array for performing microfluidic operations and can be used with a first plate which comprises an array of sample receiving elements for receiving and/or dispensing a plurality of samples from an array of sample containers. The second plate may be integral to the first plate comprising an array of sample wells. Operations can be performed by transferring at least a portion of the solutions from each of the sample wells, simultaneously or consecutively or combination thereof, to the microfluidic network, where the wells and network are coordinated to provide for accuracy of recording of the events. Of particular interest is the use of electrokinesis, more particularly electrophoresis, for moving fluids and carrying out operations, although other methods for moving fluids in a microfluidic network can find use. For convenience, kits can be provided containing the microfluidic array and reagents, which may be separate or be present in the microstructures of the individual units. The arrays of sample wells and microfluidic units provides for simultaneous or parallel operations for liquid transfer of at least aliquots from the individual wells.

In carrying out operations one can provide an integrated apparatus which may include components to perform all or some of the following steps: means for transferring aliquots of liquids from sample containers, e.g. wells; means for initial processing of the array of aliquots to provide an array of processed aliquots; transfer means for transferring the processed aliquots to an array of capillary electrophoretic units; means for simultaneously conducting capillary electrophoresis in the capillary electrophoretic array; and means for analyzing the content of the capillary electrophoretic array at a detection site.

Methodologies which may be employed involve simultaneous transfer of liquid moieties from an array of sample wells of a multiwell plate to an array of sample receiving elements, where at least a portion of each of the liquid moieties is then transferred simultaneously to a corresponding array of sample handling wells. At least a portion of each of these transferred liquid moieties is then expelled from the sample receiving elements by application of a motivating force, such as an electric field or pressure. The microfluidic networks can be in integral fluid communication with the sample receiving elements so that the expelled liquid is directed to a corresponding microstructure of a microfluidic unit.

### BRIEF DESCRIPTION OF THE DRAWINGS

FIG. 1 is a perspective view of one embodiment of one embodiment of an apparatus in accordance with the present invention.

FIG. 2 is an exploded view of the apparatus of FIG. 1.

FIG. 3 is a cross-sectional view of the apparatus of FIG. 1 taken along lines 3-3.

FIG. 4 is a perspective view of an embodiment of a microfluidic network.

FIG. 5 is a perspective view of one embodiment of a portion of a plate having a plurality of microfluidic networks.

FIG. 6 is a perspective view of another embodiment of a portion of a plate having a plurality of microfluidic networks.

FIG. 7 is a perspective view of another embodiment of a portion of a plate having a plurality of microfluidic networks.

FIG. 8 is a plan schematic view of dual 8×12 array of microfluidic units for sample injection and separation; and

FIG. 9 is a plan schematic view of an array for sample injection and component separation.

### DESCRIPTION OF THE SPECIFIC EMBODIMENTS

The present invention encompasses methods and apparatus comprising a planar array of microfluidic networks of interconnected cavity structures and channels of capillary dimensions for simultaneously conducting a plurality of microfluidic processes. The miniaturized system of enrichment trenches, reaction chambers and detection zones enable multiple laboratory processes to be integrated “on-board” a planar substrate, including sample preparation, incubation, electrophoretic separations and analyses. The subject plates allow for integration with other devices for simultaneous sampling of an array of samples, simultaneous handling of the samples and presenting an array of samples for electrophoresis, simultaneous transferring of the array of presented samples to an array of microfluidic capillary networks, and simultaneous conducting of processing of the samples in the microfluidic network.

The individual microfluidic networks comprise a plurality of reservoirs, two or more, generally not more than about 8, usually not more than about 6, where the reservoirs will have volumes ranging from about 0.01 to 100 μl, more typically 0.1 to 10 μl. Once drawn from the reservoir, sample volumes or their equivalent transported through the micro channels range from 1 pl(picoliter) to 1000 nl (nanoliters), more typically 10 to 1000 pl. Volumes of sample drawn for individual microinjected reaction or separation plugs are 0.01 pl to 10 nl, more typically 0.1 pl to 0.1 nl.

Many of these advantages may be achieved in a variety of assays including immunoassays, DNA binding assays including total DNA determinations and DNA hybridizations, receptor-ligand competitive binding assays including whole cell assays, and the like. The capability to add a common reagent to multiple samples in, for example, a 96-well or a multi-well plate, mix and react the samples and reagents in the sample containers means that a primary reaction step (e.g. displacement of a common ligand to a receptor) can be done in discrete small volumes, in parallel with precise timing, with a minimum of carry-over and cross contamination, and without contamination of the starting material (e.g. any array or library of compounds). Simultaneous transfer may be carried out with respect to all of the wells in a multiwell plate or only with respect to some of the wells thereof. For example, one may wish to transfer samples with respect to only 8 or 16 or some other number of wells in a 96 well plate. Such transfer may be achieved by employing means for independently activating the transfer device to provide simultaneous transfer for fewer than the full number of wells in a multi-well plate.

For the purposes of this invention, an “array” intends an arrangement of a plurality of elements such as a plurality of wells in a multiwell source plate, a plurality of apertures or nozzles in a sample transfer plate, a plurality of microfluidic networks on the multi-assay card, and so forth. “Planar array” intends an array that is arranged in a plane, which may he the plane of an object such as, for example, a planar substrate, comprising the array.

“Cavity structure” intends an unfilled space within a mass, preferably a hollowed out space in an object, such as, e.g. a planar substrate, a plate or the like in accordance with the present invention, such as, for example, a well, a reservoir, an incubation chamber, a separation chamber, an enrichment chamber, a detection chamber, and the like. The cavity structures are usually present at one or both of the termini, i.e., either end, of a channel. The cavity structures may serve a variety of purposes, such as, for example, means for introducing a buffer solution, elution solvent, reagent rinse and wash solutions, etc. into the main channel or one or more interconnected auxiliary channels, receiving waste fluid from the main channel, and the like. Also, the cavity structures may serve for electrode connections, sources or sinks of ions or charged sample species, or as the site for application of pressure or reduction of pressure.

“Channels” intends a conduit or means of communication, usually fluid communication, more particularly, liquid communication, between elements of the present apparatus. The elements in communication are, e.g. cavity structures, etc. Channels include capillaries, grooves, trenches, microflumes, etc. The channels may be straight, curved, serpentine, labyrinth-like or other convenient structure within the planar substrate. The cross-sectional shape of the channel may be circular, ellipsoid, square, rectangular, triangular, etc. The inside of the channel may be coated with a material for strength, for enhancing or reducing electrokinetic flow, such as polymers that are charged (electroosmotic flow) or uncharged (electrophoretic flow) or modified chemically or physically, such as electrical discharge, ozonization, chemical reactions with active agents which neutralize or add charges to the surface, etc., for enhancing detection limits and sensitivity, etc. Exemplary coatings include silylation, polyacrylamide (vinyl bound) methylcellulose, polyether, polyvinylpyrrolidone, polyethylene glycol, polypropylene, Teflon®, Nafion®, polycarbonate, polydimethylsiloxane, polynorbornene, etc. The coating may be coated on by any convenient way and when appropriate, particularly with water-soluble coatings, grafted onto the channel surface. (These coatings may also find application for the base material of the plate and/or cover, including penetration of the surface of the base material.)

“Capillary dimension ” intends a cross-sectional area that provides for capillary flow, wherein at least one dimension (width, height, diameter) is at least about 1 μm, usually at least about 10 μm and not greater than bout 500 μm, usually not greater than about 200 μm. Channels will generally have an inside bore diameter (ID) of from about 1 to 200 μm, usually about 25 to 100 μm.

“Well plate” intends a plate comprising an array of wells, which may have any number of wells greater than one, usually in a regular pattern, generally having a number of wells which is a multiple of 8, such as 96, 192, 384 or 1536 well plates, exemplified by microtiter well plates.

The subject devices may be used for electrokinetic flow, electroosmotic, electrophoretic, dielectrophoretic, etc. or other movement generating means, including applications of magnetic fields, centrifugal force, thermal gradients, pneumatic means, both reduced and elevated pressures, etc. Depending upon the nature of the electrokinetic flow, with electroosmosis there will be movement of primarily fluid as the solute carrier, but also some movement as a result of the ionic movement of the solute in relation to the electric field. In electrophoretic movement, the flow will be primarily ions, with minor fluid movement.

In carrying out the methods of this invention samples may be processed or pretreated by any number of procedures, such as separations, sample enrichment, isolation or purification, analysis, e.g. assay, detection, etc., chemical synthesis, e.g. combinatorial chemistry, polynucleotide synthesis or sequencing, oligopeptide synthesis, etc. Samples may be separated into fractions and the fractions guided to appropriate sites in a channel, where specific binding pair members, e.g. antigen-antibodies, complementary labeled components, chemically reactive components, etc., may be present. Cells, bacterial or mammalian, or viruses may be sorted by microfluidic networks in conjunction with electrical fields and then analyzed. Cell fractionation can be achieved using phase extraction materials, including paramagnetic beads, non-magnetic particles, etc., to bind with the cells such that the bead-cell complex can be separated from the other cells. Cell lysis results in releasing the intracellular materials for further analysis.

The microfluidic units provide for fluid handling, transport and manipulation within chambers and channels of capillary dimensions. Valveless sample injection is achieved by moving fluid and/or charged species from the reagent reservoirs into cross-channel injection zones, where plugs of components are precisely metered and dispensed into a desired flowpath. The rate and timing of movement of the fluids and ions in the various microchannels comprising the flowpath can be controlled by electrokinetic, magnetic, pneumatic and/or thermal-gradient driven transport, among others, as appropriate. These sample manipulation methods enable the profile and volume of the fluid plug to be controlled over a range of sizes with high reproducibility. In addition, microfluidic processing may include sample preparation and isolation where enrichment microchannels containing separation media are employed for target capture and purification. Microfluidic processing may also include reagent mixing, reaction/incubation, separations, sample detection and analyses.

The arrays will usually comprise individual units that are repeated in an organized manner. That is, each unit is the same as the other units and is spaced apart equally from surrounding units Each of the components of the units is substantially the same as the other units and will be parallel, so as to have the same spacing and configuration as the other units. That is, the reservoirs and channels will be spaced in the same manner, have the same lengths, cross-sections and volumes in each of the units. Rather than sharing a common electrode, reservoir or channel, each of units will usually act independently, so as to have independent sample reservoirs, sites for electrodes, waste reservoirs and channels connecting reservoirs.

In one embodiment, the configuration of the units conforms to the spacing format of the wells in a well plate. Conveniently, a transfer device comprising a plurality of dispenser units is employed, where the organization of the spacing and positioning of the dispenser units allows for withdrawal of liquids from a storage device, e.g. the first plate, and dispensing of the liquids into reservoirs of the second plate, without reorienting the dispensing units. The microfluidic units comprising the capillaries may be constructed by any number of means. In many instances the capillaries will be sufficiently hydrophilic to draw in several microliters of liquid aqueous sample by capillary action, although means of moving the fluid may be used, such as pneumatic pressure. A suitable capillary can be constructed from glass or silica tubing of appropriate dimensions. Instead of an inorganic plate or substrate, plastic material may be used for the plate or substrate, such as polyethylene, polypropylene, polycarbonate, polysulfone, polymethylmethacrylate, polynorbornene, etc. If desired, in the case of hydrophobic plastics, the inner bore of the plastic capillary may be treated, as is well known and previously described, to make the inner walls of the capillary sufficiently hydrophilic to draw in the sample by capillary action. In many cases, the capillary will first be filled with a buffer solution and the sample added to the device at an orifice, such as the opening to a reservoir. The sample components may then be transported into the capillary by any of the means described above.

In addition to those treatments described previously, appropriate treatments for altering the hydrophobic surface of the plastic and imparting hydrophilicity to the inner walls of the capillaries include coating the walls with a surfactant or wetting agent, grafting a layer of hydrophilic polymer onto the wall of the hydrophobic capillary or treating the walls of the capillary by plasma etching.

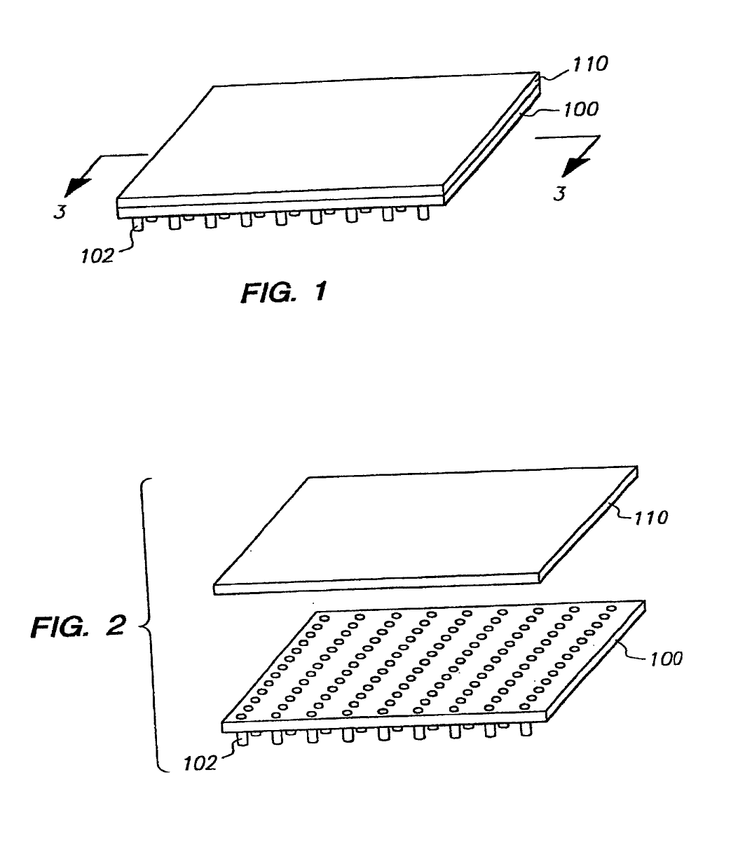

In one embodiment, in FIG. 1, sample receiving elements 102 are sipper capillaries as disclosed in U.S. Pat. No. 5,560,811, at column 9, line 53, to column 10, line 45, the disclosure of which is incorporated herein by reference. In this approach first plate 100 has an array of sample receiving elements that comprise sample handling wells with a corresponding array of sipper capillaries. The array of sipper capillaries is aligned with wells of a multiwell plate containing the samples. When the sipper capillaries are in the sample, an aliquot of sample is transferred to the sipper capillary by wicking action. The samples in the capillaries can be manipulated to be presented to the microfluidic networks in second plate 110.

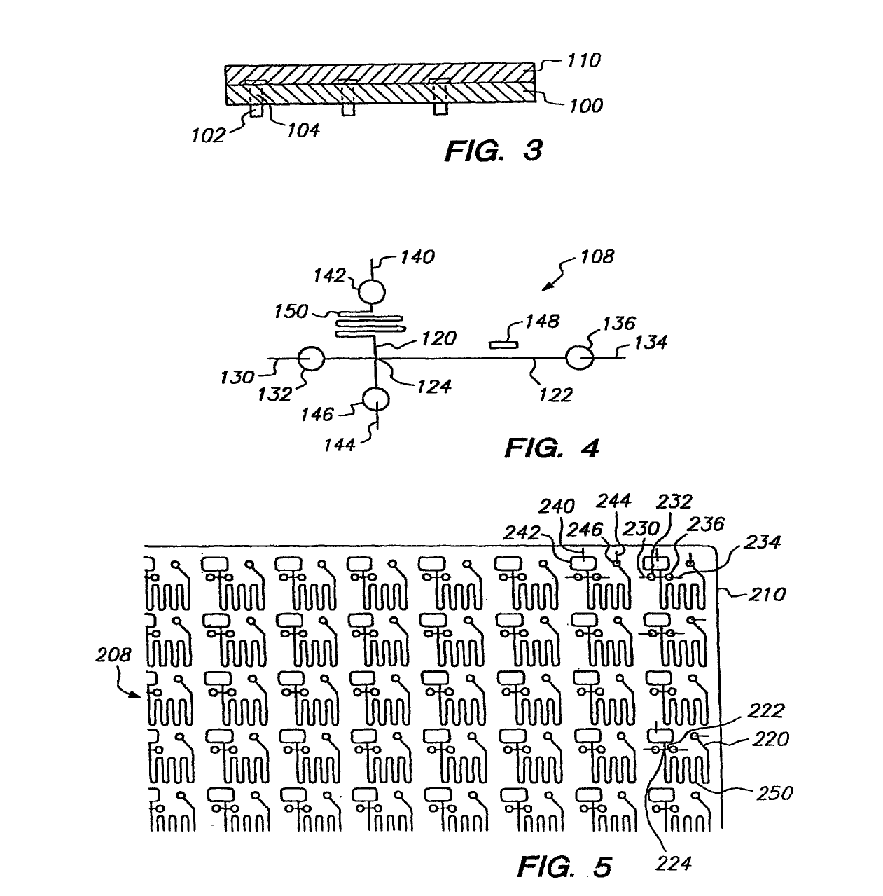

In this embodiment, in FIG. 3, first plate 100 may also comprise a matrix element 104, which is typically made of a wide variety of porous matrix materials. For most applications, the porous matrix materials should have little or no affinity for sample. Useful porous matrix materials include membrane materials such as regenerated cellulose, cellulose acetate, polysulfone, polyvinylidine fluoride, polycarbonate and the like. For DNA samples, a cellulose acetate membrane such as that available from Amicon is useful. For protein samples, a membrane composed of polysulfone such as those available from Amicon or Gelman is useful.

Alternatively, porous matrix 104 could be a porous cylindrical or spherical plug of sintered polymer particles. Such porous materials are available from Porex or Interflow and are typically comprised of a bed of small polymeric particles that have been fused together by heat and pressure (sintering) to form a porous plug of predefined geometry. In another implementation, porous matrix 104 may comprise an ultrafiltration membrane with a defined molecular weight cut off. Alternatively, porous matrix 104 could be derivatized with some biochemical agent to impart a selective binding capability to matrix 104.

The apparatus shown in FIGS. 1-3 also comprises a second plate 110 that is integral with the first plate. Second plate 110 comprises a planar array of microfluidic networks 108 having interconnected cavity structures 142 and channels 120 and 124 (see FIG. 4). Each of the microfluidic networks corresponds to a respective sample-receiving element 102. In the embodiment shown in FIGS. 1-3, the capillaries are adapted for fluid communication with cavity structure 142. Liquid is transferred from sample receiving element 102 to cavity structure 142 by, for example, application of negative pressure, thermal gradient and the like. The capillary may have a fritted element disposed therein such that capillary flow will continue until the fritted element is saturated whereupon capillary draw ceases. Transfer of the liquid can then be effected such as described above.

The liquid receiving reservoirs of the microfluidic units for receiving samples or reagents from an array of wells, will be spaced in relation to each other in the same spacing array as the source wells from which the liquid is transferred, generally spaced based on the centers of the wells. In this way, liquid can be moved from one plate to the next, where the liquid can be dispensed in the same pattern that it was withdrawn from the source.

In an embodiment wherein sample receiving elements 102 are sipper capillaries in accordance with U.S. Pat. No. 5,560,811, the apparatus also includes a means of fluid communication between plates 100 and 110. Such means of fluid communication includes, for example, a capillary between the two plates to provide for flow from the sample receiving well to the microfluidic networks of second plate 110. The capillary may extend from the sample receiving well to a cavity structure of the corresponding microfluidic network. The means of fluid communication may also be an opening in a cover plate for the second plate 100 where the opening permits liquid from the sample receiving well to be transferred mechanically, electrically, including electrostatically, and piezoelectrically, or the like into a corresponding microfluidic network of second plate 110.

The microfluidic network has interconnected cavity structures and channels, the latter forming one or more flowpaths resulting in an interconnected system. In general, there is a main flowpath and at least one, frequently more secondary flowpaths. A desired microfluidic process may be carried out in the main flowpath or in one of the secondary flowpaths. The additional flowpaths may be employed for a variety of purposes such as, for example, enrichment of a sample, isolation, purification, dilution, mixing, metering, and the like. A variety of configurations are possible, such as a branched configuration in which a plurality of flowpaths is in fluid communication with the main flowpath. See, for example, U.S. Pat. No. 5,126,022.

The main flowpath has associated with it at least one pair of electrodes for applying an electric field to the medium present in the flowpath. Where a single pair of electrodes is employed, typically one member of the pair is present at each end of the pathway. Where convenient, a plurality of electrodes may be associated with the flowpath, as described in U.S. Pat. No. 5,126,022, the relevant disclosure of which is herein incorporated by reference, where the plurality of electrodes can provide for precise movement of entities along the flowpath. The electrodes employed in the subject invention may be any convenient type capable of applying an appropriate electric field to the medium present in the flowpath with which they are associated.

An example of a basic configuration of a microfluidic network is shown in FIG. 4. Plate 110 is comprised of a plurality of microfluidic networks 108. Each network comprises main flowpath 120 and secondary flowpath 122, which intersect at 124. Electrode 130 is connected to reservoir 132 and electrode 134 is connected to reservoir 136. An electric potential can be applied to flowpath 122 by means of electrodes 130 and 134. Electrode 140 is connected to sample introduction port and reservoir 142 and electrode 144 is connected to waste reservoir 146. An electric potential can be applied to main flowpath 120 by means of electrodes 140 and 144. The main flowpath 120 has optional portion 150 that is tortuous to provide an appropriate path length and residence time to achieve mixing by diffusion, incubation, and so forth.

Secondary flowpath 122 has detection zone 148 where the result of a microfluidic process may be detected. For example, if the microfluidic process is an assay for an analyte, the detection zone permits the detection of a signal produced during the assay. Alternatively, if the microfluidic process is a chemical synthesis, the detection zone may be used to detect the presence of the synthesized compound. It is, of course, within the purview of the present invention to utilize several detection zones depending on the nature of the microfluidic process. There may be any number of detection zones associated with a single channel or with the multiple channels. (Any convenient and sufficiently sensitive mode of detection may be employed, such as radioactivity, electrochemical, chemiluminescence, fluorescence, etc. However, since fluorescence is commonly used and will therefore be used as illustrative of methods of detection.) Suitable detectors for use in the detection zones include, by way of example, photomultiplier tubes, photodiodes, photodiode arrays, avalanche photodiodes, linear and array charge coupled device (CCD) chips, CCD camera modules, spectrophotometers, spectrofluorometers, and the like. Excitation sources include, for example, filtered lamps, LED's, laser diodes, gas, liquid and solid state lasers, and so forth. The detection may be laser scanned excitation, CCD camera detection, coaxial fiber optics, confocal back or forward fluorescence detection in single or array configurations, and the like.

Detection may be by any of the known methods associated with the analysis of capillary electrophoresis columns including the methods shown in U.S. Pat. Nos. 5,560,811 (column 11, lines 19-30), 4,475,300 and 5,324,401, the relevant disclosures of which are incorporated herein by reference. An example of an optical system for reading the channels in the detection zones comprises a power supply, which energizes a photomultiplier tube. A power supply energizes a 75 watt Xenon lamp. Light from the lamp is condensed by focusing lens, which passes light to an excitation filter. A dichroic mirror directs excitation light to a microscope. The apparatus is mounted on a movable carriage so that light passes over the channels. Fluorescent emission light is collected by the microscope, passed through a dichroic mirror, emission filter, or spatial filter before reaching the photomultiplier (PMT). The output signal of PMT is fed to an analog-to-digital converter, which in turn is connected to computer.

Alternatively, a static detection system in which a stationary detection point some distance from the injection end of the capillary is monitored as bands to be analyzed traverse the length of the capillary and pass by the detection zone could be used. This type of detection could be implemented using optical fibers and lenses to deliver the excitation radiation to the capillary and to collect the fluorescent emission radiation from the detection zone in the capillary. Appropriate multiplexing and demultiplexing protocols might be used to sequentially irradiate and monitor a large array of capillaries using a single source and a single or a small number of photodetectors. Using this approach, each capillary in the array is sequentially polled to detect any analyte band in the detection zone of that capillary.

The detectors may be part of an instrument into which the present apparatus is inserted. The instrument may be the same instrument that comprises the electrode leads and other components necessary for utilizing the present apparatus. However, separate instruments may be used for housing a sample container plate, incubation of sample and reagents, detection of a result, electrical field application, and other operations such as temperature and humidity control, and so forth. Humidity control may be achieved in a number of ways such as, for example, the use of humidistats, water vapor sources confined in the device in fluid communication with other areas thereof, and so forth. Other methods of humidity control will be evident to those skilled in the art.

Generally, prior to using a microfluidic network, a suitable electroflow medium as described above is introduced into the flowpaths defined by the channels in the second or microfluidic plate. The medium may be conveniently introduced through one of the reservoirs at the termini of each of the channels.

The use of a microfluidic network is next discussed with reference to FIG. 4. Sample is introduced into sample introduction port and reservoir 142 together with appropriate reagents for carrying out a microfluidic process. An electric potential is applied across electrodes 140 and 144 causing medium containing the sample and other reagents to move through flowpath 120 and, in particular, portion 150 and 120. Mixing of sample and reagents, as well as incubation, take place in portion 150. When the portion of the medium containing the sample and reagents reaches intersection 124, the electric potential applied between electrodes 140 and 144 is discontinued and an electric potential is applied between electrodes 130 and 134. The point at which the sample and other reagents reach intersection 124 may be determined by detecting the presence of the sample or one of the reagents directly or by empirically determining the time at which the sample and reagents should reach the intersection 124, based on the particular nature of the sample, the medium employed, the strength of the electric potential and so forth. Application of the electrical potential to electrodes 130 and 134 causes a plug of medium of precise amount (determined by the dimensions of the channel) to move along secondary flowpath 122 towards reservoir 136 and through detection zone 148 where detection is conducted. This is the basic manner in which an exemplary microfluidic network operates. Of course, as will be appreciated by one of ordinary skill in the art, the precise manner of operation of microfluidic networks in an apparatus in accordance with the present invention is dependent on the construction of the apparatus.

Considerations include, for example, whether reagents are present on board the apparatus or added from a source outside the apparatus. Other considerations include manipulation of beads or magnetic beads in the channels, filling of channels with buffer, manipulation of discrete drops within otherwise unfilled channels, method of fluid movement (electroosmotic, electrokinetic, surface tension, centrifugal, pneumatic), mixing two or more reagents, incubation, and so forth.

Those skilled in the electrophoresis arts will recognize a wide range of electric potentials or field strengths may be used, for example, fields of 10 to 1000 V/cm are used with 200-600 V/cm being more typical. The upper voltage limit for commercial systems is 30 kV, with a capillary length of 40-60 cm, giving a maximum field of about 600 V/cm. There are reports of very high field strengths (2500-5000 V/cm) with short, small bore (10 microns) capillaries micro machined into an insulating substrate. Normnal polarity is to have the injection end of the capillary at a positive potential. The electroosmotic flow is normally toward the cathode. Hence, with normal polarity all positive ions and many negative ions will run away from the injection end. Generally, the “end capillary” detector will be near the cathode.

The polarity may be reversed for strongly negative ions so that they run against the electroosmotic flow. For DNA, typically the capillary is coated to reduce electroosmotic flow, and the injection end of the capillary is maintained at a negative potential.

Examples of devices that are suitable for the second plate in the above-integrated apparatus are provided in FIGS. 5-7. Only a portion of the microfluidic network plates is shown in FIGS. 5-7. It is to be understood that the microfluidic network plates may have any number of separate networks including more than or less than 96. The number of microfluidic networks my be multiples of 96 where the number is greater than 96 or multiples of 8 where the number is less than 96. In addition, some of the features of the microfluidic networks are not shown in all of the networks depicted in FIGS. 5-7.

In FIG. 5 a portion of a plate 210 is shown where the plate may have up to ninety-six (96) microfluidic networks 208. Each network comprises main flowpath 220 and secondary flowpath 222, which intersect at 224. Electrode 230 is connected to reservoir 232 and electrode 234 is connected to reservoir 236. An electric potential can be applied to secondary flow path 222 by means of electrodes 230 and 234. Electrode 234 is connected to sample introduction port and reservoir 236 and electrode 230 is connected to reservoir 232. An electric potential can be applied between electrodes 2309 and 234, so that sample ions are moved past the intersection between main flowpath 220 and secondary flowpath 222. An electric potential can then be applied to main flowpath 220 by means of electrodes 240 and 244, whereby sample ions move from the intersection into the main flowpath 220. The main flowpath 220 has a portion 250 that is in the form of a linear reciprocating coil to provide a tortuous path.

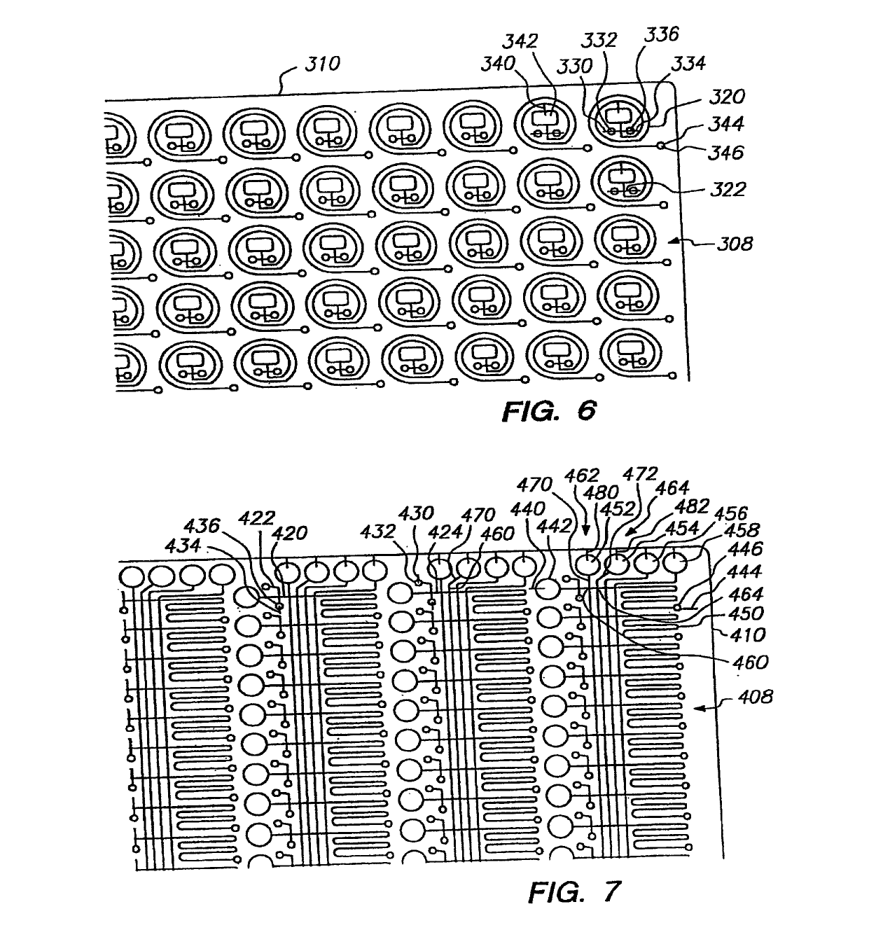

In FIG. 6 a portion of a plate 310 is shown where the plate may have up to ninety-six (96) microfluidic networks 308. Each network comprises main flowpath 320 and secondary flowpath 322, which intersect at 324. Electrode 330 is connected to reservoir 332 and electrode 334 is connected to reservoir 336. An electric potential can be applied to secondary flow path 322 by means of electrodes 330 and 334. Electrode 334 is connected to sample introduction port and reservoir 336 and electrode 330 is connected to reservoir 332. As described above, the sample ions can be moved by a voltage gradient created by electrodes 330 and 334 to move the sample ions to the intersection 324 of the flowpaths 322 and 320. An electric potential can be applied to main flowpath 320 by means of electrodes 340 and 344 to move the sample ions into the main flowpath 320 for further processing. The main flowpath 320 is a circular coil to provide a tortuous path.

In FIG. 7 a portion of a plate 410 is shown where the plate may have up to ninety-six (96) microfluidic networks 408. Each network comprises main flowpath 420 and secondary flowpath 422, which intersect at 424. Electrode 430 is connected to reservoir 432 and electrode 434 is connected to reservoir 436. An electric potential can be applied to secondary flowpath 422 by means of electrodes 430 and 434. Electrode 430 is connected to sample introduction port and reservoir 432 and electrode 434 is connected to reservoir 436. An electric potential can be applied to secondary flowpath 422 by means of electrodes 430 and 434 and to main flowpath 420 by means of electrodes 440 and 444. The main flowpath 420 has a portion 450 that is in the form of a linear reciprocating coil to provide a tortuous path. The microfluidic networks of the plate of FIG. 6 also comprise a set of reagent reservoirs 452, 454, 456 and 458. Each of the reagent reservoirs has a channel providing communication between the reagent reservoir and each of the main flowpaths of the microfluidic networks. Accordingly, reagent reservoir 452 has a channel 470 that intersects main flowpaths 420 at 460 for each of the microfluidic networks in row 462 of plate 410. Likewise, reagent reservoir 454 has a channel 472 that intersects main flowpath 420 at 464 for each of the microfluidic networks in row 464 of plate 410. The same situation exists for reagent reservoirs 456 and 458. Reagents are moved through channels 470 and 472 by means of application of electrical potential at electrodes 480 and 482, respectively. By appropriate alternation of electric potential in channels 470 and 472 on the one hand and main channel 420 on the other, precise amounts of reagents can be metered into main flowpath 420.

With regard to electrodes, some or all of the electrodes may be within the second or microfluidic plate, with external connections to power supplies that may be part of an instrument into which the present apparatus is inserted. On the other hand, some or all of the electrodes might be on a separate part (e.g. built into an instrument into which the present apparatus is inserted), such that the electrodes can be immersed into the appropriate fluid reservoirs at the time of use. In this approach the electrodes in the separate instrument may be adapted to make contact with an appropriate lead from each of the reservoirs forming a part of the microfluidic networks in the subject apparatus. The electrodes may be strip metal electrodes formed in a stamping process or chemical etching process. The electrodes may be wires or strips either soldered or glued with epoxy and can be made of conductive materials such as platinum, gold, carbon fibers and the like. The electrodes could be deposited, coated or plated onto a section of the exterior wall of a capillary near each end of the capillary. Controlled vapor deposition of gold, platinum or palladium metal onto the exterior wall of the capillary is one method of forming the electrodes. This technique can be used to produce an electrode layer with a thickness up to several microns. Thicker electrodes could be subsequently formed by electrochemically plating gold, palladium or platinum onto the thin electrode formed by the vapor deposition process. Electrodes could be integral with the second plate formed by silk screening process, printing, vapor position, electrode-less plating process, etc. Carbon paste, conductive ink, and the like could be used to form the electrode.

Regardless of the embodiment of the present invention that is constructed, it is preferable for the electrodes to be connected to an electronic computer. The computer has programmed software dedicated to providing the moving waves or voltage profile along the channel. Various different types of software can be provided so as to obtain the best possible results in the particular microfluidic processing conducted.

It is also within the purview of the present invention that the computer software that is connected to the electrodes be made interactive with an optical detection device such as ultraviolet or fluorescence spectrometer. The spectrometer can be focused singly or at various points along the medium in the channels. As the ultraviolet spectrometer reads different types of substances being moved to different portions of the medium, the information can be sent to the computer, which can adjust the speed of the waves or voltage distribution profiles being generated in order to more precisely fine tune the resolution of the substances being moved through the medium.

As mentioned above, the channels can be in any shape. More specifically the channels can be fashioned so that it has a plurality of branches. Each of the branches along with the channel itself can be filled with a desired medium. Various reagents may be moved along the branches by utilizing the moving electric wave generated by the computer. Accordingly, a sophisticated computer program may be utilized to provide for various protocols for microfluidic processing such as chemical synthesis, sequencing of polynucleotides.

The integrated apparatus of the present invention may have any convenient configuration capable of comprising the first and second plates and their respective component parts. The cavities and channels of the second plate are usually present on the surface of a planar substrate where the substrate will usually, though not necessarily be covered with a cover plate to seal the microfluidic networks present on the surface of the planar substrate from the environment. The cover plate will have appropriate communication means for establishing communication between each of the sample receiving elements of the first plate and the corresponding microfluidic network of the second plate. Such means include, for example, through-holes, capillaries, porous wicks and the like. The apparatus may have a variety of configurations such as, for example, rectangular, circular, or other convenient configuration. Generally, apparatus in accordance with the present invention are of a size that is readily handled and manipulated. In general, a rectangular apparatus has dimensions of about 3 inches by 5 inches; a circular apparatus has a diameter of about 4 to 16 inches; and each would have a thickness of at least about 0.2 inches, usually about 0.60 to 1.5 inches (including all of the elements of the apparatus). It should be obvious that the size of the present devices and apparatus is not critical and is in general a function of the particular multiwell plate with which the present device may be used.

The apparatus may be fabricated from a wide variety of materials, including glass, silica, quartz, ceramics and polymers, including elastomeric material, thermosets and thermoplastics, e.g., acrylics, and the like. The various components of the apparatus may be fabricated from the same or different materials, depending on a number of factors such as, e.g., the particular use of the device, the economic concerns, solvent compatibility, optical clarity, color, mechanical strength, dielectric properties, e.g., dielectric strength greater than 100 V/cm, and so forth. For example, the planar substrate of the second plate may be fabricated from the same material as the cover plate, e.g., polymethylmethacrylate, or from different materials such as, e.g., polymethylacrylate for the substrate and glass for the cover plate. Likewise, the first plate may be fabricated from the same material as the second plate, or one of the components of the second plate, e.g., glass bottom, glass top; plastic bottom, plastic cover, or from different materials such as, e.g., glass for the first plate and plastic for the second plate.

For applications where it is desired to have a disposable integrated device, due to ease of manufacture and cost of materials, the device typically is fabricated from a plastic. For ease of detection and fabrication, the entire apparatus may be fabricated from a plastic material that is optically transparent, which generally allows light of wavelengths ranging from 180 to 1500 nm, usually 220 to 800 nm, more usually 450 to 700 nm, to have low transmission losses. Suitable materials include fused silica, plastics, quartz, glass, and so forth.

Also of interest as materials suitable for fabrication of one or more components of the present apparatus are plastics having low surface charge under conditions or electroflow. Particular plastics finding use include polymethyl methacrylate, polymethyl acrylate, polycarbonate, polyethylene terephthlate, polystyrene or styrene copolymers, polyesters, polynorbornene, and the like.

The apparatus may be fabricated using any convenient means, including conventional molding and casting techniques, extrusion sheet forming, calendaring, embossing, thermoforming, and the like. For example, with apparatus prepared from plastic materials, a silicon mold master, which is the negative for the network structure in the planar substrate of the second plate, can be prepared by etching or laser micromachining. In addition to having a raised ridge that forms the channel in the substrate, the silicon mold may have a raised area that provides for one or more cavity structures in the planar substrate. Next, a polymer precursor formulation can be thermally cured or photopolymerized between the silica master and support planar plate, such as a glass plate. Where convenient, the procedures described in U.S. Pat. No. 5,110,514, the relevant disclosure of which is incorporated by reference, may be employed. After the planar substrate has been fabricated, electrodes may be introduced where desired.

For the second plate cavity structures or reservoirs may be formed by boring holes only part way through the substrate at the ends of the channels, so that the cavity structures are not open on the opposite surface of the second plate. Holes can be bored or cut through the cover and aligned with the cavity structures. Liquids can be added to cavity structures formed in this manner, which can be filled through holes in the cover, rather than from the opposite side.

The substrate for the second plate may take a variety of shapes such as, for example, disk-like, card-like, and may be a layered or laminated sandwich structure. The substrate for the second plate is usually about 1 μm thick, usually at least about 5 μm, and more usually at least about 50 μm thick, where the thickness may be as great as 5 mm or greater.

As mentioned above, the second plate may be constructed from two or more parts, usually two parts, e.g., a base plate and a cover plate. Each part generally has a planar surface and the parts are sealed together so that the planar surfaces are opposed. The planar surface of the base plate usually includes one or more cavity structures and channels, while the planar surface of the cover plate may or may not include one or more cavity structures and channels.

The cover plate is usually placed over, and sealed to, the surface of the substrate of the base plate, although it may be a base plate enclosing the bottoms of the microstructures. The cover or under plate may be sealed to the substrate using any convenient means, including ultrasonic welding, adhesives, etc., and the base plate will come within the parameters for the cover plate. The cover may be a more or less rigid plate, or it may be a film, and the thickness of the cover may be different for materials having different mechanical properties. Usually the cover ranges in thickness from at least about 200 μm, more usually at least about 500 μm, to as thick as usually about 5 mm or thicker, more usually about 2 mm. The cover substrate may be fabricated from a single material or be fabricated as a composite material. In some instances the cover is of a plastic material, and it may be rigid or elastomeric.

In one approach the apparatus may have multiple layers that are sandwiched together similar to multiple layer electronic printed circuit boards. In this approach the apparatus may be made in a manner similar to the printed circuit boards. Each layer contains cavities, channels and through-holes. When the various plates are assembled into an apparatus, the channels and through-holes in each layer can interconnect forming three dimensional fluid circuits. This approach allows significantly greater circuit complexity and circuit density than the single layer approach.

Another approach for the transfer of liquids from the first plate to the second plate of the present apparatus involves a plurality of active liquid transfer elements corresponding to each well of a multiwell plate. Upon activation of the active liquid transfer elements, an amount of liquid from the well of the well plate is actively transferred to a microfluidic network of the second plate through a corresponding through-hole in the second plate. Exemplary of active liquid transfer elements include capillary droplet ejectors that are driven mechanically, electrically, pneumatically, thermally, and so forth, and capillary forces and surface tension, hydrodynamics, and the like.

The arrays of microfluidic units may be produced in a continuous manner, by having at least two continuous films, where one film is embossed to introduce depressions that serve as the microstructures and a second film encloses the channel microstructures while providing ports for the reservoir microstructures. The films may be drawn from rollers simultaneously and after embossing one film, the other film may be adhered to the embossed film to provide a continuous film of a plurality of arrays. Alternatively, slits may be introduced into one film, where the slits will serve as the microstructures and the slit film sandwiched between a support enclosing film and a cover film which has openings for the reservoirs for introducing liquids into the reservoirs.

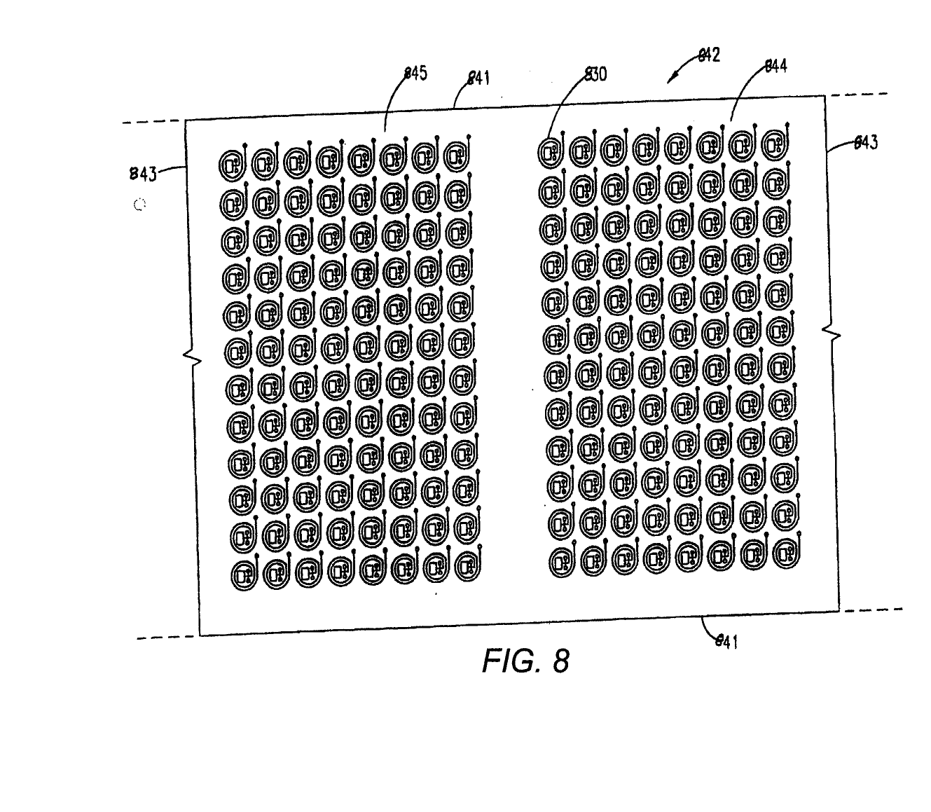

FIG. 8 depicts two arrays of a film having a continuous series of arrays. The figure illustrates a way in which the arrangement of the microchannel structures in the array can be made to match the geometry of, for example, a 96-well plate Such an arrangement can facilitate automated transfer of samples or of test compounds from a standard plate to a continuous form microchannel device, providing for efficient transfer with reduced waste and minimal cross-contamination. The figure shows a short segment of an elongate flexible film laminate containing a series of microchannel arrays. The elongate film laminate 842 extends lengthwise beyond the range of the drawing, as indicated by broken lines extending from the edges 841 of the short segment. The short segment shown, which is limited by lines 843, includes two successive microchannel arrays of microstructures 844, 845. Each of the microchannel arrays 844, 845 containing 96 microchannel structures 830, is configured and arranged in an orthogonal 12×8 grid that conforms to the geometry of a conventional 96-well plate, with nominal 9 mm centers.

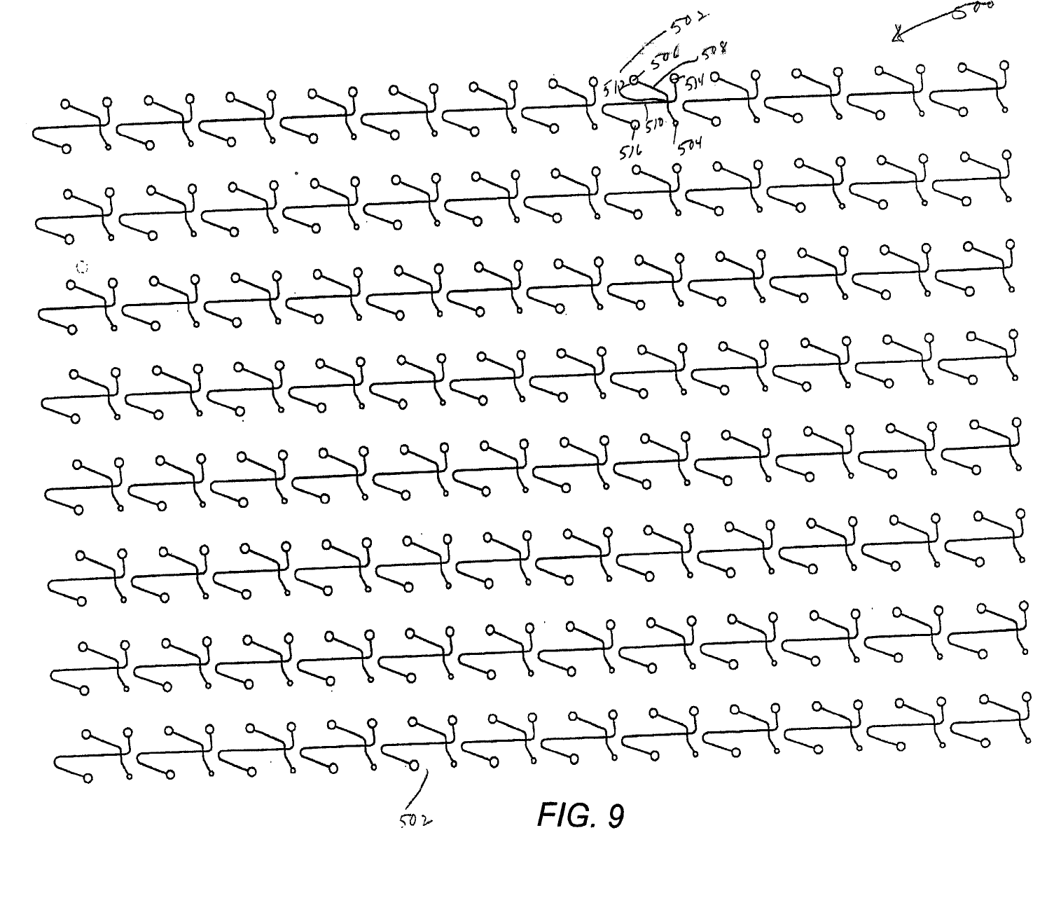

FIG. 9 depicts a plan schematic view of individual microfluidic units in an 8×12 array with a footprint associated with a 96 well microtiter plate, whereby the samples from the microtiter plate may be directly transferred to a reservoir for analysis. The microfluidic unit array has 96 individual units 502, which are substantially identical. Each unit has a small cavity structure 504 that serves as the sample reservoir for receiving a sample and receiving an electrode during the processing of the sample. The sample reservoir 504 is connected to waste reservoir 506 by means of injection channel 508, which crosses a long channel 510 at intersection 512, where the long channel 510 can serve as a separation or other processing channel. The long channel 510 connects buffer reservoir 514 and waste reservoir 516. In operation, electrodes are introduced into each of the reservoirs, 504, 506, 514 and 516. By providing a voltage gradient in the injection channel 508, sample ions move in the channel 508 and past the intersection 512. When the intersection has the same composition as the sample reservoir 504, the field may be switched by means of electrodes in reservoirs 514 and 516, whereby the sample ions in the intersection is moved into the long channel 510 and may be further processed, such as separation into individual components.

The subject invention provides many benefits in providing arrays of microfluidic units in a single plate or substrate, where operations can be performed in parallel. This allows for simultaneous and parallel additions of samples, reagents and diluents to the individual devices under the same conditions, such as temperature, humidity and time. Also, the substrate is subjected to the same conditions during the operation, allowing for direct comparison of results. Where two or more of the same operations are carried out, one can obtain an accurate standard deviation, since the operations will be substantially under the same conditions. Also, by employing arrays of pipetters, that have the same organization as micro titer well plates, samples may be withdrawn from the micro titer well plates and directly transferred to the subject devices, where the samples will have the same relationship as they had in the micro titer well plate. In this way, the samples may go through a plurality of operations, with the same spatial relationship in each of the operations, greatly reducing the possibility of confusion, cross-contamination and increasing the ability to monitor individual samples. The subject devices simplify automation and computer monitoring of data by maintaining the orientation of samples through transfers and processing.

Each reference and patent application cited herein is incorporated by reference as if the reference was set forth verbatim in the text of this specification.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

What is claimed is:

1. A microfluidic unit array comprising a plurality of microfluidic units in an organized array, each unit comprising a microfluidic network of reservoirs connected by interconnected channels of capillary dimensions including a primary flowpath and at least one secondary flowpath, each unit having a reservoir positioned in the array in the same format of a source array of at least one of samples and reagents.

2. A microfluidic unit array according to claim 1, wherein the number of units is a multiple of 8 and each of the rows of units has at least 8 units.

3. A microfluidic unit array according to claim 1, wherein said format is a 96 well micro titer well format.

4. A microfluidic unit array, wherein said microfluidic unit array comprises a substrate in which microfluidic units of said microfluidic unit array are formed, said microfluidic units comprising a microfluidic network of a plurality of reservoirs connected by interconnected channels including a primary flowpath and at least one secondary flowpath, and a film enclosing said interconnected channels, wherein reservoirs for receiving at least one of samples and reagents are positioned in the array in the same format of a source array, wherein said source array is a microtiter well plate having a number of wells equal to a multiple of 8.

5. A microfluidic unit array according to claim 4, wherein said substrate is plastic.

6. A microfluidic unit array according to claim 4, further comprising electrodes positioned for contact with liquid in said receiving reservoirs.

7. A microfluidic unit array according to claim 6, in combination with a plate comprising wells for receiving liquid.

8. In a method for performing a plurality of simultaneous operations employing microfluidic devices, involving the transfer of liquids from an array of wells, the improvement which comprises:
employing a microfluidic unit array according to claim 1.
